(19) United States
(12) Patent Application Publication
(10) Pub. No.: US 2026/0094588 A1
(43) Pub. Date: Apr. 2, 2026

(54) ELECTRONIC APPARATUS, NON-TRANSITORY COMPUTER-READABLE MEDIUM, AND OUTPUT METHOD

(71) Applicant: Roland Corporation, Shizuoka (JP)

(72) Inventor: Ryo SUSAMI, Hamamatsu, Shizuoka (JP)

(73) Assignee: Roland Corporation, Shizuoka (JP)

(21) Appl. No.: 19/120,796

(22) PCT Filed: Jan. 16, 2023
(86) PCT No.: PCT/JP2023/000991

§ 371 Date: Apr. 14, 2025

(51) Int. Cl. G10H 1/00

(52) U.S. Cl. CPC G10H 1/0066; G10H 2210/091

(57) ABSTRACT

An electronic apparatus includes: a performance information reception part, receiving pieces of performance information from an external apparatus; a TS reception part, receiving, from the external apparatus, timestamps relating to respective execution timings of the pieces of performance information; a reference timing setting part, in a case where one piece of performance information is received, setting a timing based on a reception timing of the one piece of performance information as a reference timing; and a scheduled output timing setting part, setting, as a scheduled output timing being a timing of outputting another piece of performance information received, a timing calculated by adding a time difference between a timestamp received by the TS reception part that corresponds to the another piece of performance information and a timestamp received by the TS reception part that corresponds to the one piece of performance information to the reference timing set.

### TECHNICAL FIELD

The disclosure relates to an electronic apparatus, an output program, and an output method.

### RELATED ART

Patent Document 1 discloses an electronic musical instrument 10 that receives a MIDI message via wireless communication from a device 30 composed of a portable terminal, and generates a tone of the received MIDI message. Specifically, a timestamp according to a time relating to an execution timing of a MIDI message is transmitted together with the MIDI message from the device 30 to the electronic musical instrument 10.

In the electronic musical instrument 10, in the case where an initial MIDI message is received from the device 30, the tone generation of that MIDI message is performed at a time calculated by adding a predetermined offset time to a time at which that MIDI message is received, and that time is further taken as a “reference time.” The tone generation of a subsequent MIDI message is performed at a time calculated by adding, to the reference time, a time difference between a timestamp of the initial MIDI message and a timestamp of the MIDI message of which the tone is generated.

In this way, in the electronic musical instrument 10, the offset time is provided as a grace period from reception until tone generation of a MIDI message. Thus, even if jitter (fluctuation) or latency (delay) occurs in the communication of the MIDI message, it is possible to generate the tone while maintaining the time difference with the MIDI message of which the tone is generated earlier.

### Prior-Art Documents

### Patent Documents

Patent Document 1: Japanese Patent Laid-open No. 2022-96035 (for example, paragraphs 0073 to 0079, FIG. 7C and FIG. 7D)

### SUMMARY

### Problems to Be Solved by the Invention

Here, in the electronic musical instrument 10 of Patent Document 1, in FIG. 7C, a tone of a subsequent MIDI message is generated at a time (hereinafter referred to as “scheduled output time”) calculated by adding, to the reference time based on the initial MIDI message, the time difference between the timestamp of the MIDI message of which the tone is generated and the timestamp of the initial MIDI message.

For example, if a MIDI message M1 of which a tone is generated is received later than the scheduled output time due to jitter or latency, the tone of the MIDI message M1 is immediately generated after reception. Furthermore, if a MIDI message M2 immediately subsequent thereto is received earlier than the scheduled output time, a tone of the MIDI message M2 is generated at the scheduled output time. Thus, due to the delayed reception of MIDI message M1, a time difference from the tone generation of the MIDI message M1 to the tone generation of the MIDI message M2 is shorter than a time difference between their timestamps, and there is a risk that a listener may feel discomfort such as perceiving a tone generation timing of the MIDI message M2 as too early.

Furthermore, in FIG. 7D, the tone of the initial MIDI message is generated after waiting for the offset time from the arrival of the initial MIDI message at a reception side. The scheduled output time for the subsequent MIDI message is set to a time calculated by adding, to the reference time based on a tone generation timing of the initial MIDI message, the time difference between the timestamp of the MIDI message of which the tone is generated and the timestamp of the initial MIDI message. Accordingly, a tone generation interval between each MIDI message can be maintained even if jitter occurs. However, there is a problem that, when the offset time is set to a fixed value, excessive latency that originally could have been avoided may occur.

The disclosure has been made in order to solve the above problem, and an object thereof is to provide an electronic apparatus, an output program, and an output method in which, in the case of outputting a MIDI message received from an external apparatus, the listener's discomfort with respect to a tone generation timing of the MIDI message can be suppressed and the occurrence of latency can be suppressed.

### Means for Solving the Problems

To achieve this object, an electronic apparatus of the disclosure includes: a performance information reception part, receiving pieces of performance information from an external apparatus; a TS reception part, receiving, from the external apparatus, timestamps relating to respective execution timings of the pieces of performance information received by the performance information reception part; a reference timing setting part, in a case where one piece of performance information is received by the performance information reception part at a predetermined timing, setting a timing based on a reception timing of the one piece of performance information as a reference timing; and a scheduled output timing setting part, setting, as a scheduled output timing being a timing of outputting another piece of performance information received by the performance information reception part, a timing calculated by adding a time difference between a timestamp received by the TS reception part that corresponds to the another piece of performance information and a timestamp received by the TS reception part that corresponds to the one piece of performance information to the reference timing set by the reference timing setting part. In a case where the scheduled output timing set by the scheduled output timing setting part is at or before a reception timing of the another piece of performance information, the reference timing setting part sets a timing based on the reception timing as the reference timing.

An output program of the disclosure is a program causing a computer to execute processing for outputting received performance information. The output program causes the computer to execute: a performance information reception step, in which pieces of performance information are received from an external apparatus; a TS reception step, in which timestamps relating to respective execution timings of the pieces of performance information received by the performance information reception step are received from the external apparatus; a reference timing setting step, in which, in a case where one piece of performance information is received by the performance information reception step at a predetermined timing, a timing based on a reception timing of the one piece of performance information is set as a reference timing; and a scheduled output timing setting step, in which, as a scheduled output timing being a timing of outputting another piece of performance information received by the performance information reception step, a timing calculated by adding a time difference between a timestamp received by the TS reception step that corresponds to the another piece of performance information and a timestamp received by the TS reception step that corresponds to the one piece of performance information to the reference timing set by the reference timing setting step is set. In the reference timing setting step, in a case where the scheduled output timing set by the scheduled output timing setting step is at or before a reception timing of the another piece of performance information, a timing based on the reception timing is set as the reference timing.

An output method of the disclosure includes: a performance information reception step, in which pieces of performance information are received from an external apparatus; a TS reception step, in which timestamps relating to respective execution timings of the pieces of performance information received by the performance information reception step are received from the external apparatus; a reference timing setting step, in which, in a case where one piece of performance information is received by the performance information reception step at a predetermined timing, a timing based on a reception timing of the one piece of performance information is set as a reference timing; and a scheduled output timing setting step, in which, as a scheduled output timing being a timing of outputting another piece of performance information received by the performance information reception step, a timing calculated by adding a time difference between a timestamp received by the TS reception step that corresponds to the another piece of performance information and a timestamp received by the TS reception step that corresponds to the one piece of performance information to the reference timing set by the reference timing setting step is set. In the reference timing setting step, in a case where the scheduled output timing set by the scheduled output timing setting step is at or before a reception timing of the another piece of performance information, a timing based on the reception timing is set as the reference timing.

### BRIEF DESCRIPTION OF THE DRAWINGS

FIG. 1(a) is an external view of a synthesizer and a portable terminal; (b) is a diagram showing a timing of a MIDI message transmitted from the portable terminal; (c) is a diagram showing a timing of reception and tone generation of a MIDI message in the synthesizer.

FIG. 2 is a functional block diagram of the synthesizer.

FIG. 3(a) is a block diagram showing an electrical configuration of the synthesizer; (b) is a diagram schematically showing a delay output buffer.

FIG. 4(a) is a flowchart of main processing of the synthesizer; (b) is a flowchart of timer processing.

FIG. 5(a) is a diagram describing offset time in a second embodiment; (b) is a diagram showing a timing of a MIDI message transmitted from the portable terminal in the second embodiment; (c) is a diagram showing a timing of reception and tone generation of a MIDI message in the synthesizer in the second embodiment; (d) is a diagram schematically showing a flash ROM in the synthesizer of the second embodiment.

FIG. 6 is a flowchart of the main processing of the synthesizer in the second embodiment.

FIG. 7(a) is a flowchart of the main processing of the portable terminal in a modification; (b) is a diagram describing advancement of a reference time in the modification.

### DESCRIPTION OF THE EMBODIMENTS

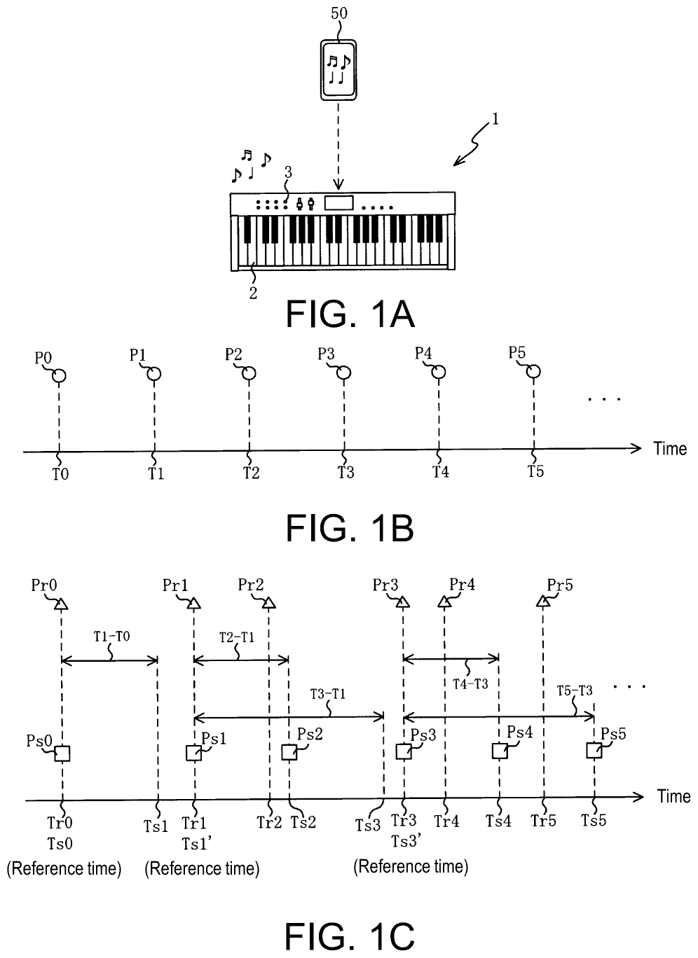

Hereinafter, preferred embodiments will be described with reference to the accompanying drawings. An outline of a synthesizer 1 of the present embodiment is described with reference to FIG. 1(a). FIG. 1(a) is a diagram describing an outline of the synthesizer 1 and a portable terminal 50.

The synthesizer 1 is a device (electronic musical instrument or electronic apparatus in a broad sense) that generates musical tones based on performance of a user H, or musical instrument digital interface (MIDI) messages being performance information received from an external apparatus such as the portable terminal 50 described later. The synthesizer 1 includes a keyboard 2 that acquires operation information based on an operation of the user H, and a setting button 3 for the user H to input various settings. The synthesizer 1 is connected to the portable terminal 50 via wireless communication such as Wi-Fi or Bluetooth (both registered trademarks).

The portable terminal 50 is an information processing device (computer) that performs processing according to an instruction input from the user H. The portable terminal 50 is configured to be capable of transmitting a MIDI message according to the instruction from the user H to an external apparatus. Here, the transmission of a MIDI message by the portable terminal 50 and the tone generation of the MIDI message received from the portable terminal 50 by the synthesizer 1 are described with reference to FIG. 1(b) and (c).

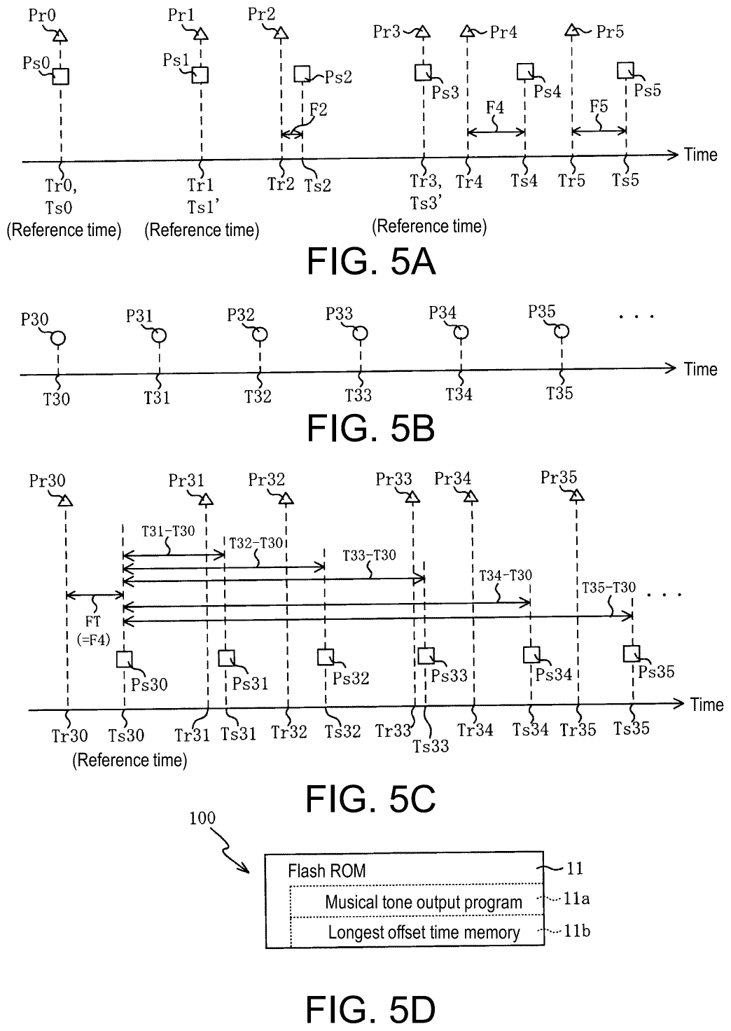

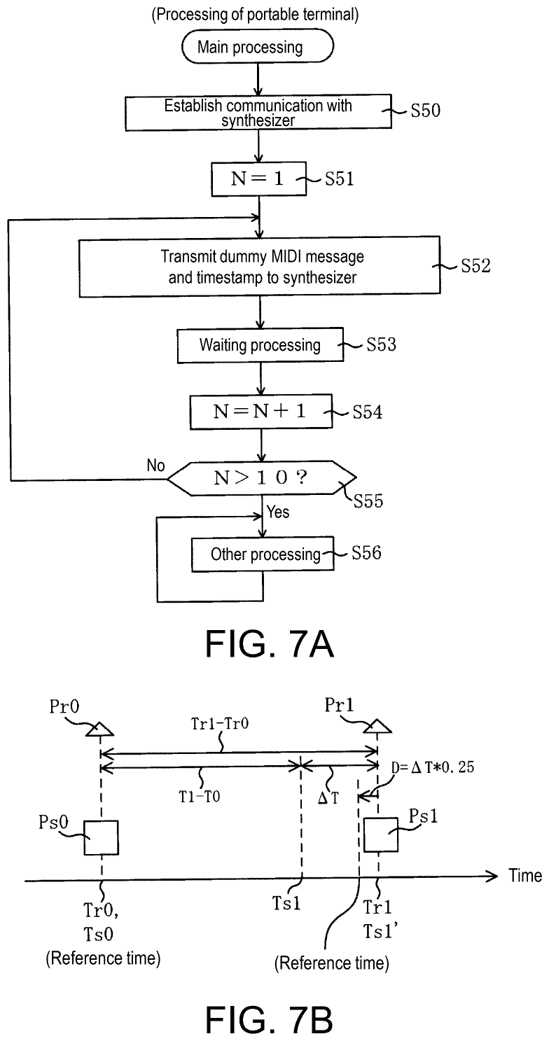

FIG. 1(b) is a diagram showing a timing of a MIDI message transmitted from the portable terminal 50. The horizontal axis in FIG. 1(b) represents time, and the same applies to FIG. 1(c), FIG. 5 and FIG. 7 described later. As shown in FIG. 1(b), MIDI messages are transmitted from the portable terminal 50 at transmission timing PO to transmission timing P5 at time T0 to time T5.

To simplify the description, in the present embodiment, the time between time T0 and time T1, the time between time T1 and time T2, the time between time T2 and time T3, the time between time T3 and time T4, and the time between time T4 and time T5 each are a constant time (for example, 100 milliseconds). However, the intervals between each time may be different. The number of MIDI messages transmitted from the portable terminal 50 are not limited to 6 at transmission timing PO to transmission timing P5, and may be 6 or less or 6 or more.

A timestamp consisting of information about a time at which a MIDI message is transmitted is also transmitted to the synthesizer 1 together with the MIDI message. For example, in a timestamp of the MIDI message at transmission timing P0, information relating to time T0 is set; in a timestamp of the MIDI message at transmission timing P3, information relating to time T3 is set. As will be described in detail later, the timestamp is used for controlling the timing at which a tone of the corresponding MIDI message is generated in the synthesizer 1.

Such MIDI messages and corresponding timestamps transmitted from the portable terminal 50 are received by the synthesizer 1, and corresponding musical tones are generated from the synthesizer 1. A timing of reception and tone generation of a MIDI message in the synthesizer 1 is described with reference to FIG. 1(c).

FIG. 1(c) is a diagram showing a timing of reception and tone generation of a MIDI message in the synthesizer 1. The MIDI messages transmitted from the portable terminal 50 at transmission timing P0 to transmission timing P5 are received by the synthesizer 1 at reception timing Pr0 to reception timing Pr5, respectively. Reception timing Pr0 to reception timing Pr5 correspond to time Tr1 to time Tr5, respectively.

Since these MIDI messages are transmitted from the portable terminal 50 to the synthesizer 1 via wireless communication, “jitter,” which is fluctuation in communication, or “latency,” which is delay in communication, may occur depending on communication status. Hence, reception timing Pr0 to reception timing Pr5 have temporal variations compared to transmission timing P0 to transmission timing P5 described above in FIG. 1(b).

For example, reception timing Pr1 is delayed due to latency. Accordingly, a time difference Tr1−Tr0 between reception timing Pr1 and the preceding reception timing Pr0 is larger than a time difference T1−T0 between the corresponding transmission timing P1 and transmission timing P0. On the other hand, reception timing Pr2 fluctuates due to jitter. Accordingly, a time difference Tr2−Tr1 between reception timing Pr2 and the preceding reception timing Pr1 is smaller than a time difference T2−T1 between the corresponding transmission timing P2 and transmission timing P1.

In this way, since reception timing Pr0 to reception timing Pr5 have temporal variations compared to transmission timing P0 to transmission timing P5, even if the tones of the MIDI messages are generated as they are at reception timing Pr0 to reception timing Pr5, the tones are not generated with time differences conforming to the original transmission timing P0 to transmission timing P5 transmitted from the portable terminal 50. Accordingly, in the present embodiment, by setting a reference time that serves as a reference for the timing of tone generation according to reception timing Pr0 to reception timing Pr5, deviation from the time differences conforming to the original transmission timing P0 to transmission timing P5 is suppressed.

Specifically, in the case where the synthesizer 1 receives the initial MIDI message (that is, at reception timing Pr0) from the portable terminal 50, time Tr0 corresponding to reception timing Pr0 is set as scheduled output time Ts0 being a time at which the tone of the MIDI message is generated. That is, scheduled output time Ts0 is taken as tone generation timing Ps0 of generating the tone of the initial MIDI message.

In the synthesizer 1, in the case where the set scheduled output time is at or before the current time, a tone of the corresponding MIDI message is generated. Thus, since time Tr0 corresponding to reception timing Pro is set as scheduled output time Ts0 for the initial MIDI message, the tone of this message is immediately generated after reception. By generating the tone of the initial MIDI message immediately after reception, a time lag from the start of transmission of the MIDI message at the portable terminal 50 and the start of tone generation at the synthesizer 1 can be suppressed. Accordingly, the listener's discomfort with respect to the start of tone generation of the MIDI message can be suppressed.

In the present embodiment, the “initial MIDI message” refers to a MIDI message first received by the synthesizer 1 from the portable terminal 50 after power-on, and a MIDI message received by the synthesizer 1 from the portable terminal 50 after a predetermined time (for example, 15 seconds) or more has elapsed since the receipt of the last MIDI message from the portable terminal 50.

In this way, time Tr0 and time Ts0 at which the initial MIDI message is received and the tone thereof is generated are set as a reference time (reference timing) being a time that serves as a reference for the tone generation timing of a subsequent MIDI message, and a timestamp of the initial MIDI message is set as a reference timestamp that serves as a reference for the tone generation timing.

The tone generation timing of the subsequent MIDI message is set to a time calculated by adding, to time Tr0 and time Ts0 being the reference time, a time difference between a timestamp of the subsequent MIDI message and the timestamp of the initial MIDI message being the reference timestamp.

Accordingly, the time difference between the tone generation timing of the initial MIDI message set at the reference time and the tone generation timing of the subsequent MIDI message can be made equivalent to a time difference between the timestamps of the corresponding MIDI messages transmitted from the portable terminal 50. Thus, the tone of the subsequent MIDI message can be generated while an appropriate time difference with the initial MIDI message set at the reference time is maintained. As will be described later in detail, the reference time and reference timestamp may be reset according to a temporal relationship between the reception timing and the scheduled output time of the MIDI message.

The second MIDI message following the initial MIDI message is received at time Tr1 being reception timing Pr1. Scheduled output time Ts1 for the second MIDI message is set to a time calculated by adding, to the reference time (that is, time Tr0 of reception timing Pr0 of the initial MIDI message), the time difference T1−T0 between time T1 of transmission timing P1 of the second MIDI message and the reference timestamp (that is, the timestamp of the initial MIDI message).

Scheduled output time Ts1 set in this way is taken as a time at or before time Tr1 of reception timing Pr1 of the second MIDI message. Since the tone of the MIDI message is generated in the case where the scheduled output time is at or before the current time, the tone of the second MIDI message is immediately generated at time Tr1 being reception timing Pr1. This time is taken as scheduled output time Ts1′, and is taken as tone generation timing Ps1 of the second MIDI message.

In other words, the tone of the second MIDI message is generated later than scheduled output time Ts1 that is set according to the reference time and reference timestamp based on the initial MIDI message. Accordingly, a situation can be suppressed where the tone generation of the second MIDI message received later than the originally assumed scheduled output time Ts1 may be further delayed.

However, in such a state in which the reference time and reference timestamp remain being based on the initial MIDI message after the tone generation of the second MIDI message has been delayed, when the scheduled output time for the third MIDI message is set, a time difference from when the tone of the second MIDI message is generated until the scheduled output time for the third MIDI message may be less than the time difference T2−T1 between the corresponding transmission timing P1 and transmission timing P2. Accordingly, there is a risk that the listener may feel that the tone of the third MIDI message is generated too early and may feel discomfort with respect to the tone generation of the third MIDI message.

Accordingly, in the present embodiment, for a MIDI message for which the scheduled output time is at or before the reception timing and the tone generation has been delayed, the reception timing is reset as the reference time, and the timestamp of the MIDI message is newly reset as the reference timestamp.

In the case of the second MIDI message, time Tr1 and time Ts1′ at which the second MIDI message is received and the tone thereof is generated are newly set as the reference time, and the timestamp of the second MIDI message is set as the reference timestamp. The scheduled output time for the third and subsequent MIDI messages is set using the reference time and reference timestamp that are reset based on the second MIDI message.

Scheduled output time Ts2 for the third MIDI message following the second MIDI message is set to a time calculated by adding, to the reference time (that is, time Tr1 and time Ts1′ of reception timing Pr1 of the second MIDI message), the time difference T2−T1 between time T2 of transmission timing P2 of the third MIDI message and the reference timestamp (that is, the timestamp of the second MIDI message).

The third MIDI message is received at time Tr2 of reception timing Pr2. Since time Tr2 is taken as a timing earlier than set scheduled output time Ts2, the tone of the third MIDI message is generated at scheduled output time Ts2, and scheduled output time Ts2 is taken as tone generation timing Ps2. Accordingly, the tone of the third MIDI message can be generated while the time difference T2−T1 with transmission timing P1 of the second MIDI message is maintained.

Like the second MIDI message described above, the fourth MIDI message following the third MIDI message is received at a timing later than scheduled output time Ts3 for the fourth MIDI message. Thus, like the second MIDI message described above, the tone of the fourth MIDI message is generated at time Tr3 of tone generation timing Ps3, time Tr3 and time Ts3′ at which the fourth MIDI message is received and the tone thereof is generated are reset as the reference time, and the timestamp of the fourth MIDI message is set as the reference timestamp.

Like the third MIDI message described above, the fifth MIDI message following the fourth MIDI message is received at a timing earlier than scheduled output time Ts4 for the fifth MIDI message. Thus, the tone of the fifth MIDI message is generated at scheduled output time Ts4. Similarly, the sixth MIDI message following the fifth MIDI message is received at a timing earlier than scheduled output time Ts5 for the sixth MIDI message. Thus, the tone of the sixth MIDI message is generated at scheduled output time Ts5.

In this way, in the case where a MIDI message is received at a timing later than a scheduled output time calculated by adding a time difference between a timestamp of the MIDI message and a reference timestamp to a reference time, the tone of the MIDI message is immediately generated, and a reception timing and the timestamp of the MIDI message are reset as the reference time and the reference timestamp.

Then, a scheduled output time for a MIDI message subsequent to the MIDI message is set based on the reset reference time and reference timestamp. Accordingly, since a time difference between a tone generation timing of the subsequent MIDI message and a tone generation timing of the MIDI message used for resetting the reference time and reference timestamp can be determined based on a time difference between the timestamps of these MIDI messages, the listener's discomfort with respect to the tone generation timing of the subsequent MIDI message can be suppressed.

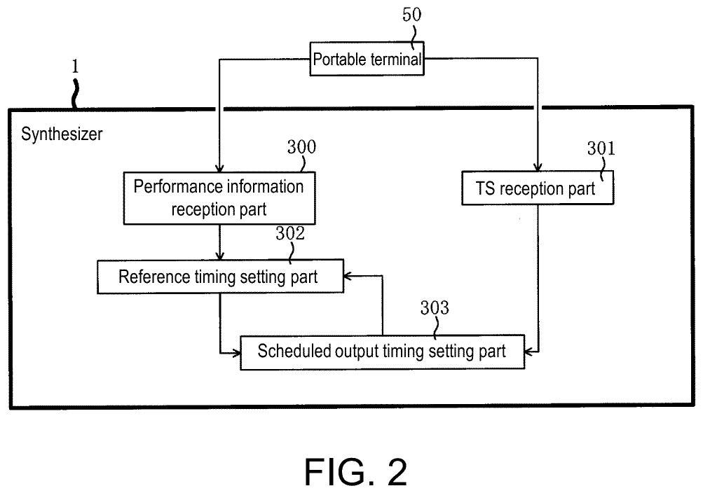

Next, a function of the synthesizer 1 is described with reference to FIG. 2. FIG. 2 is a functional block diagram of the synthesizer 1. As shown in FIG. 2, the synthesizer 1 includes a performance information reception part 300, a TS reception part 301, a reference timing setting part 302, and a scheduled output timing setting part 303.

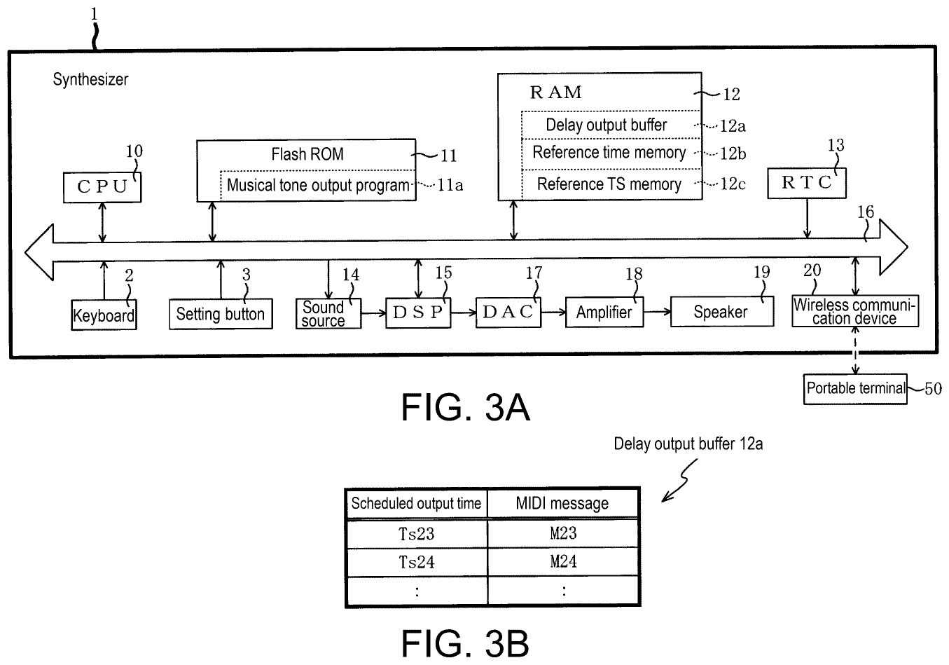

The performance information reception part 300 is a means of receiving a MIDI message from the portable terminal 50, and may be implemented by a CPU 10 described later in FIG. 3. The TS reception part 301 is a means of receiving, from the portable terminal 50, a timestamp relating to an execution timing of the MIDI message received by the performance information reception part 300, and may be implemented by the CPU 10.

The reference timing setting part 302 is a means of, in the case where one MIDI message is received by the performance information reception part 300 at a predetermined timing, setting a timing based on a reception timing of the one MIDI message as a reference time, and may be implemented by the CPU 10. The scheduled output timing setting part 303 is a means of setting, as a scheduled output time being a timing of generating (outputting) a tone of another MIDI message received by the performance information reception part 300, a timing calculated by adding, to the reference time set by the reference timing setting part 302, a time difference between a timestamp received by the TS reception part 301 that corresponds to the another MIDI message and a timestamp received by the TS reception part 301 that corresponds to the one MIDI message, and may be implemented by the CPU 10.

In the case where the scheduled output time set by the scheduled output timing setting part 303 is at or before a reception timing of the another MIDI message, the reference timing setting part 302 sets a timing based on the reception timing as the reference time. Furthermore, in the case where the initial MIDI message is received by the performance information reception part 300, the reference timing setting part 302 sets a reception timing of the initial MIDI message as the reference time. The scheduled output timing setting part 303 sets the reception timing of the initial MIDI message as a scheduled output timing for the initial MIDI message.

The MIDI message is received from the portable terminal 50, and the timestamp relating to the execution timing of the received MIDI message is received. In the case where one MIDI message is received at a predetermined timing, a timing based on the reception timing of the one MIDI message is set as the reference time. As a scheduled output time for generating a tone of another MIDI message, a timing calculated by adding a time difference between a timestamp corresponding to the another MIDI messages and a timestamp corresponding to the one MIDI message to the reference time is set. Here, in the case where the scheduled output time is at or before the reception timing of the corresponding MIDI message, a timing based on the reception timing is set as the reference time.

That is, in the case where there is a delay MIDI message which is received at a timing later than the scheduled output time, the reference time is reset based on that delay MIDI message. Then, the scheduled output time for a subsequent MIDI received after that delay MIDI message is set based on the reset reference time. Accordingly, since a time difference between the tone generation timing of the subsequent MIDI message and the tone generation timing of the delay MIDI message can be determined based on a time difference between the timestamps of these MIDI messages, the listener's discomfort with respect to the tone generation timing of the subsequent MIDI message can be suppressed.

In the case where the initial MIDI message is received by the performance information reception part 300, the tone of that MIDI message is immediately generated. Accordingly, since a time lag from the start of transmission of a MIDI message from the portable terminal 50 to the start of tone generation of the MIDI message by the synthesizer 1 can be suppressed, latency of the MIDI message can be suppressed.

Next, an electrical configuration of the synthesizer 1 is described with reference to FIG. 3. FIG. 3(a) is a block diagram illustrating the electrical configuration of the synthesizer 1. The synthesizer 1 includes the CPU 10, a flash ROM 11, a RAM 12, a real-time clock (RTC) 13 that measures date and time, the keyboard 2 and setting button 3 described above, a sound source 14, a digital signal processor (DSP) 15, and a wireless communication device 20 for wireless communication with the portable terminal 50, each of which is connected via a bus line 16. A digital-to-analog converter (DAC) 17 is connected to the DSP 15, an amplifier 18 is connected to the DAC 17, and a speaker 19 is connected to the amplifier 18.

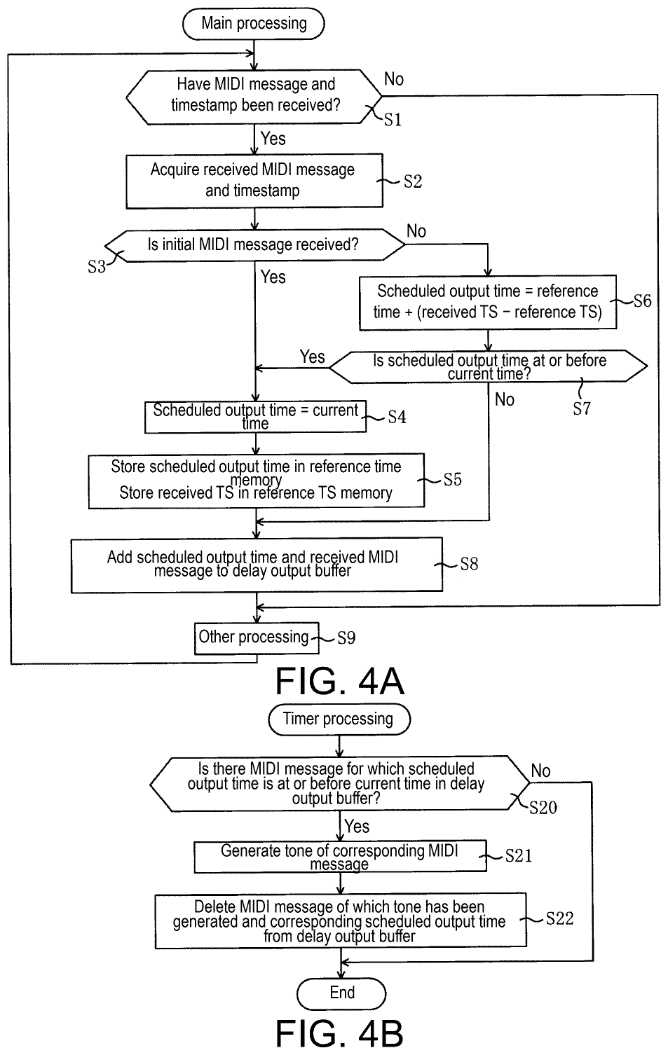

The CPU 10 is an arithmetic unit that controls each part connected by the bus line 16. The flash ROM 11 is a rewritable nonvolatile memory and includes a musical tone output program 11a. When the musical tone output program 11a is executed by the CPU 10, main processing of FIG. 4(a) is executed.

The RAM 12 is a memory rewritably storing various work data or flags or the like when the CPU 10 executes a program such as the musical tone output program 11a. The RAM 12 includes a delay output buffer 12a, a reference time memory 12b in which the reference time described above is stored, and a reference TS memory 12c in which the reference timestamp described above is stored. The delay output buffer 12a is described with reference to FIG. 3(b).

FIG. 3(b) is a diagram schematically showing the delay output buffer 12a. As shown in FIG. 3(b), the delay output buffer 12a stores the scheduled output time described above in association with a MIDI message corresponding to that scheduled output time respectively.

Back to FIG. 3(a), the sound source 14 is a device that outputs waveform data according to information input from the CPU 10. The DSP 15 is an arithmetic unit for arithmetically processing the waveform data input from the sound source 14. The DAC 17 is a conversion device that converts the waveform data input from the DSP 15 into analog waveform data. The amplifier 18 is an amplification device that amplifies the analog waveform data output from the DAC 17 with a predetermined gain. The speaker 19 is an output device that emits (outputs) analog waveform data amplified by the amplifier 18 as a musical tone.

Next, the processing executed by the CPU 10 of the synthesizer 1 is described with reference to FIG. 4. FIG. 4(a) is a flowchart of the main processing of the synthesizer 1. The main processing is processing executed when the synthesizer 1 is powered on. In the main processing, first, it is confirmed whether a MIDI message and a timestamp have been received from the portable terminal 50 via the wireless communication device 20 (S1).

If a MIDI message and a timestamp have been received in the processing of S1 (S1: Yes), the received MIDI message and timestamp are acquired (S2). After the processing of S2, it is confirmed whether the received MIDI message is the initial MIDI message (S3).

If the received MIDI message is the initial MIDI message in the processing of S3 (S3: Yes), the current time, that is, a reception timing of the MIDI message, is set as a scheduled output time (S4). The current time is acquired from the RTC 13 described above. After the processing of S4, the scheduled output time set by the processing of S4 is stored as a reference time in the reference time memory 12b, and the timestamp acquired by the processing of S2 is stored as a reference timestamp in the reference TS memory 12c (S5).

On the other hand, if the received MIDI message is not the initial MIDI message in the processing of S3 (S3: No), a time calculated by adding a time difference between the timestamp acquired by the processing of S2 and the reference timestamp in the reference TS memory 12c to the reference time in the reference time memory 12b is set as the scheduled output time (S6). After the processing of S6, it is confirmed whether the current time (that is, the reception timing) is at or after the scheduled output time set by the processing of S6 (S7). If the scheduled output time set by the processing of S6 is at or before the current time in the processing of S7 (S7: Yes), since this is a case where the MIDI message is received later than the scheduled output time, the processing of S4 onward described above is executed.

After the processing of S5, or if the scheduled output time is after the current time due to the processing of S6 in the processing of S7 (S7: No), the scheduled output time set by S4 or S6 and the MIDI message acquired by the processing of S2 are added to the delay output buffer 12a (S8). A tone of the MIDI message added to the delay output buffer 12a is generated by timer processing described later in FIG. 4(b).

If a MIDI message and a timestamp have not been received in the processing of S1 (S1: No), or after the processing of S8, other processing (S9) of the synthesizer 1 is executed, and the processing of S1 onward is repeated.

Next, the timer processing is described with reference to FIG. 4(b). FIG. 4(b) is a flowchart of the timer processing. The timer processing is processing executed every constant time (for example, 50 milliseconds) in the CPU 10 of the synthesizer 1.

In the timer processing, first, it is confirmed whether there is a MIDI message for which the scheduled output time is at or before the current time in the delay output buffer 12a (S20). If there is a MIDI message for which the scheduled output time is at or before the current time in the delay output buffer 12a in the processing of S20 (S20: Yes), a tone of the corresponding MIDI message is generated (S21). Specifically, by acquiring the waveform data corresponding to the corresponding MIDI message from the sound source 14, and outputting the acquired waveform data to the DSP 15, DAC 17, amplifier 18, and speaker 19, the tone of the MIDI message is generated as a musical tone.

After the processing of S21, the MIDI message of which the tone has been generated by the processing of S21 and the scheduled output time corresponding to that MIDI message are deleted from the delay output buffer 12a (S22). If there is no MIDI message for which the scheduled output time is at or before the current time in the delay output buffer 12a in the processing of S20 (S20: No), or after the processing of S22, the timer processing is ended.

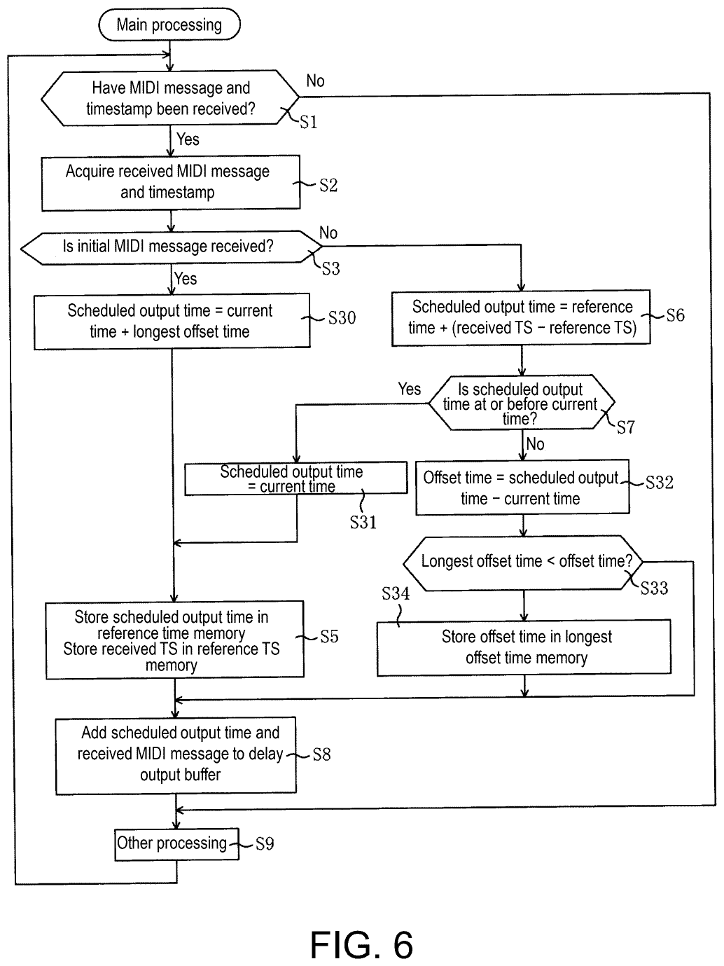

Next, a second embodiment will be described with reference to FIG. 5 and FIG. 6. In the synthesizer 1 of the first embodiment described above, in the case where the scheduled output time for a MIDI message is at or before a reception timing of that MIDI message, the reception timing is set as the reference time, and a timestamp corresponding to that MIDI message is set as the reference timestamp.

In a synthesizer 100 of the second embodiment, in addition to the above, an offset time being a time difference between a reception timing and a tone generation timing of each MIDI message is acquired. The longest offset time among the acquired offset times is added to the reception timing of the next initial MIDI message that occurs, and the result of addition is set as the scheduled output time and the reference time for the initial MIDI message. The same reference numerals denote the same portions as those in the first embodiment, and descriptions thereof are omitted.

FIG. 5(a) is a diagram describing the offset time in the second embodiment. FIG. 5(a) illustrates a timing of reception and tone generation of a MIDI message equivalent to that described in FIG. 1(c). In FIG. 5(a), in the case where the reception timing is at or before the scheduled output time, like the third MIDI message or the fifth and sixth MIDI messages, a time lag from reception until tone generation of the MIDI message occurs.

For example, for the third MIDI message, a time F2 occurs between scheduled output time Ts2 and time Tr2 of reception timing Pr2; for the fifth MIDI message, a time F4 occurs between scheduled output time Ts4 and time Tr4 of reception timing Pr4; and for the sixth MIDI message, a time F5 occurs between scheduled output time Ts5 and time Tr5 of reception timing Pr5.

The times F2, F4, and F5 are taken as “delay times” which are generated by postponing the tone generation from original scheduled output time Ts1 and original scheduled output time Ts3 (see FIG. 1(c)) to scheduled output time Ts1′ and scheduled output time Ts3′ due to delayed reception of the second and fourth MIDI messages that occur at or before the times F2, F4, and F5. That is, the time F4 which is the longest time among the times F2, F4, and F5 is taken as the longest possible delay time in the reception and tone generation of this series of MIDI messages.

Accordingly, in the second embodiment, a time difference between the scheduled output time and the reception timing in a series of MIDI messages is acquired. Among them, a longest time FT (time F4 in FIG. 5(a)) is added to the reception timing of the initial MIDI message in the next series of MIDI messages. The time difference between the scheduled output time and the reception timing is hereinafter referred to as “offset time.”

The acquisition of the offset time for the series of MIDI messages is performed until the synthesizer 100 is powered off, or until a predetermined time (for example, 15 seconds) has elapsed since receipt of the last MIDI message from the portable terminal 50. The longest offset time FT is set from the acquired offset times.

FIG. 5(b) is a diagram showing a timing of a MIDI message transmitted from the portable terminal 50 in the second embodiment; FIG. 5(c) is a diagram showing a timing of reception and tone generation of a MIDI message in the synthesizer 100 in the second embodiment. As shown in FIG. 5(a), the synthesizer 100 is powered off after receiving MIDI messages at reception timing Pr0 to reception timing Pr5 and generating tones. At this time, the “offset time F4” is set as the longest offset time FT.

After that, the power is turned on again, and MIDI messages are then transmitted from the portable terminal 50 at transmission timing P30 to transmission timing P35 (time T30 to time T35), as shown in FIG. 5(b). On this occasion, as in the first embodiment, timestamps of time T30 to time T35 at which the MIDI messages are transmitted are transmitted together with the MIDI messages.

Such MIDI messages and corresponding timestamps transmitted at transmission timing P30 to transmission timing P35 from the portable terminal 50 are received by the synthesizer 100, and tone generation is performed. On this occasion, as shown in FIG. 5(c), the tone of the initial MIDI message is generated at time Ts30 which is calculated by adding the longest offset time FT to time Tr being reception timing Pr30 (that is, time Ts30 is set as the scheduled output time for the initial MIDI message). Time Ts30 is set as the reference time. Furthermore, the timestamp of the initial MIDI message is set as the reference timestamp. As in the first embodiment described above, the tone of the subsequent MIDI messages is generated at times calculated by adding, to the set reference time, the time difference between the timestamp of the received MIDI message and the reference timestamp.

Here, the reference time is a time calculated by adding the longest offset time FT to time Tr30 being reception timing Pr30 of the initial MIDI message. The longest offset time FT is taken as the longest possible delay time in the reception and tone generation of the previous series of MIDI messages. That is, the longest offset time FT has been considered in the reference time in advance. Thus, even if the reception of MIDI messages after that is delayed, it can be prevented that the scheduled output time occurs at or before the reception timing.

Accordingly, since the tone generation of MIDI messages can be stably performed in accordance with the time differences based on timestamps transmitted by the portable terminal 50, the listener's discomfort with respect to the tone generation timing can be suppressed.

Next, an electrical configuration of the second embodiment is described with reference to FIG. 5(d). FIG. 5(d) is a diagram schematically showing the flash ROM 11 in the synthesizer 100 of the second embodiment. The flash ROM 11 in the synthesizer 100 of the second embodiment includes, in addition to the musical tone output program 11a described above, a longest offset time memory 11b in which the longest offset time FT described above is stored.

Next, the main processing of the synthesizer 100 of the second embodiment is described with reference to FIG. 6. FIG. 6 is a flowchart of the main processing of the synthesizer 100 in the second embodiment. If the received MIDI message is the initial MIDI message in the processing of S3 (S3: Yes), instead of the processing of S4 described above, a time calculated by adding the longest offset time FT in the longest offset time memory 11b to the current time is set as the scheduled output time (S30). After the processing of S30, the processing of S5 described above is executed.

If the scheduled output time set by the processing of S6 is at or before the current time in the processing of S7 (S7: Yes), the current time, that is, the reception timing of the MIDI message, is set as the scheduled output time (S31). The processing of S31 is equivalent to the processing of S4 described above.

On the other hand, if the scheduled output time set by the processing of S6 is after the current time in the processing of S7 (S7: No), a time from the scheduled output time set by the processing of S6 to the current time is set as an offset time (S32). After the processing of S32, it is confirmed whether the offset time set by the processing of S32 is longer than the longest offset time FT in the longest offset time memory 11b (S33).

In the processing of S33, if the offset time set by the processing of S32 is longer than the longest offset time FT in the longest offset time memory 11b after the processing of S32 (S33: Yes), the offset time set by the processing of S32 is stored in the longest offset time memory 11b (S34).

In the processing of S33, if the offset time set by the processing of S32 is equal to or less than the longest offset time FT in the longest offset time memory 11b (S33: No), or after the processing of S34, the processing of S8 onward is executed.

Although the disclosure has been described above based on the above embodiments, it can be easily inferred that various improvements or modifications may be made.

In the above embodiments, a MIDI message (hereinafter referred to as “tone generation MIDI message”) for tone generation is transmitted from the portable terminal 50, and a reference time and a reference timestamp are set together with the tone generation of the tone generation MIDI message in the synthesizers 1 and 100. However, the disclosure is not limited thereto. Before the tone generation MIDI message is transmitted from the portable terminal 50, a dummy MIDI message that does not include information such as timbre or scales and does not perform tone generation may be transmitted, and the reference time and reference timestamp may be set using the dummy MIDI message received by the synthesizers 1 and 100.

Specifically, in the main processing of the portable terminal 50 in a modification shown in FIG. 7(a), first, wireless communication with the synthesizers 1 and 100 is established (S50), and a counter variable N is set to 1 (S51). After the processing of S51, a dummy MIDI message and a timestamp of a time at which the dummy MIDI message is transmitted are transmitted to the synthesizers 1 and 100 (S52). After the processing of S52, waiting processing is performed (S53). The waiting processing in the processing of S53 may be waiting processing for a constant time (for example, 100 milliseconds) or waiting processing for a random time.

After the processing of S53, 1 is added to the counter variable N (S54), and it is confirmed whether the counter variable N after addition is greater than 10 (S55). In the processing of S55, if the counter variable N is 10 or less (S55: No), the processing of S52 onward is repeated.

In the synthesizers 1 and 100 in which the dummy MIDI message transmitted from the portable terminal 50 has been received by the processing of S52, the reference time and reference timing are set by the processing of S1 to S8 described above in FIG. 4 and FIG. 6. On this occasion, if a target MIDI message is a dummy in the processing of S21 in FIG. 4(b), no tone generation is performed since the MIDI message contains no information such as timbre or scales. However, a display part of the synthesizers 1 and 100 may display that a dummy MIDI message is being received.

On the other hand, in the processing of S55, if the counter variable N is greater than 10 (S55: Yes), other processing (S56) of the portable terminal 50 is repeated. The other processing of S56 also includes processing for transmitting the tone generation MIDI message and the timestamp thereof to the synthesizers 1 and 100.

In this way, the dummy MIDI message is transmitted from the portable terminal 50 before the transmission of the tone generation MIDI message. In the synthesizers 1 and 100, the reference time and reference timestamp are set by means of the dummy MIDI message before the receipt of the tone generation MIDI message. Accordingly, in the synthesizers 1 and 100, the tone generation MIDI message can be received and the tone thereof can be generated using the reference time and reference timestamp that have taken into account a communication status such as jitter or latency between the portable terminal 50 and the synthesizers 1 and 100 from the beginning. Thus, a situation can be suppressed where, during the tone generation of a series of MIDI messages, the scheduled output time may occur at or before the reception timing, and the tone generation timing may deviate from a timing based on the time difference between the timestamps. Thus, the tone generation of the MIDI message can be stably performed.

In the processing of S52 to S55, the number of times of transmitting the dummy MIDI message is not limited to 10, and may be 10 or more or 10 or less. The dummy MIDI message is not limited to being transmitted before the tone generation MIDI message. For example, in addition to before the tone generation MIDI message, the dummy MIDI message may be transmitted between tone generation MIDI messages.

In the above embodiments, in the case where the scheduled output time for the MIDI message is at or before the reception timing, the reference time is reset to the reception timing. However, the disclosure is not limited thereto. The reference time may be reset to a time ahead of the reception timing. For example, as shown in FIG. 7(b), in the case where scheduled output time Ts1 for the MIDI message is at or before time Tr1 being reception timing Pr1, the reference time may be set to a time ahead of time Tr1 by a time calculated by multiplying a time difference ΔT between time Tr1 and scheduled output time Ts1 by a predetermined coefficient (for example, 0.25).

In this way, by advancing the reference time from the reception timing, it can be suppressed that latency of subsequent MIDI messages may become unnecessarily large due to large jitter (in a time delay direction) that rarely occurs. Since the time by which the reference time is advanced is based on the time difference ΔT between reception timing Pr1 and scheduled output time Ts1, it can be suppressed that the set reference time becomes an unnecessarily early timing such as one before scheduled output time Ts1. Accordingly, since the frequency with which the reception timing is at or later than the scheduled output time in subsequent MIDI messages can be reduced, the tone of MIDI messages can be stably generated.

The time by which the reference time is advanced is not limited to a time based on the time difference ΔT between the reception timing and the scheduled output time, and may be, for example, the smaller of a fixed time (30 milliseconds) and the time difference ΔT.

In the above embodiments, in the processing of S7 in FIG. 4, if the scheduled output time set by the processing of S6 is at or before the reception timing, the reception timing is reset as the reference time, and the timestamp of that MIDI message is reset as the reference timestamp. However, the disclosure is not limited thereto. For example, regardless of the temporal relationship between the scheduled output time and the reception timing, the reception timing may always be set as the reference time, and the timestamp of the MIDI message may always be set as the reference timestamp.

In the above embodiments, in a timestamp of a MIDI message transmitted from the portable terminal 50, a time at which the MIDI message is transmitted is set. However, the disclosure is not limited thereto. For example, in a timestamp, a time at which the synthesizers 1 and 100 receiving the MIDI message generate the tone may be set. In a timestamp, a timing (execution timing) relating to output of the MIDI message or the like may be set.

In the second embodiment, as the reference time, a time calculated by adding the longest offset time FT acquired by the reception and tone generation of the previous MIDI message to the reception timing of the initial MIDI message is set. However, in setting the reference time, what is added to the reception timing of the initial MIDI message is not limited to the longest offset time FT. For example, a time longer or shorter than the longest offset time FT may be added. What is added may be an average value or median value of the offset times acquired by the reception and tone generation of the previous MIDI message, or other time relating to the offset time.

The reference time may be set by adding, to the reception timing of the initial MIDI message, a time shorter than the longest offset time FT, which may be obtained by multiplying the longest offset time FT by a predetermined coefficient less than 1, or by subtracting a fixed value from the longest offset time FT, or the like. Accordingly, it can be suppressed that latency of subsequent MIDI messages may become unnecessarily large due to large jitter (in a time delay direction) that rarely occurs.

In the above embodiments, the performance information handled by the synthesizers 1 and 100 is exemplified by MIDI messages. However, the disclosure is not limited thereto. Information other than MIDI messages may be used as the performance information.

In the above embodiments, in the processing of S21 in FIG. 4(b), the tone of the MIDI message is generated. However, the disclosure is not limited thereto. For example, in addition to or instead of generating the tone of the MIDI message, the MIDI message may be transmitted to any other electronic apparatus via the wireless communication device 20, or the MIDI message may be output in any other manner.

In the above embodiments, the synthesizers 1 and 100 are connected to the portable terminal 50 by wireless communication. However, the communication method is not limited thereto. For example, the synthesizers 1 and 100 may be connected to the portable terminal 50 by wired communication or any other communication method.

In the above embodiments, the musical tone output program 11a is stored in the flash ROM 11 of the synthesizers 1 and 100 and is operated on the synthesizers 1 and 100. However, the disclosure is not limited thereto. The musical tone output program 11a may be operated by any other electronic musical instrument such as an electronic piano or electronic organ, or an electronic drum, or the musical tone output program 11a may be operated on any other computer or electronic apparatus such as a personal computer (PC), or a portable terminal or tablet terminal.

The external apparatus that transmits MIDI messages to the synthesizers 1 and 100 is composed of the portable terminal 50. However, the disclosure is not limited thereto. The external apparatus may be composed of any other computer such as a PC or tablet terminal, or may be composed of an electronic musical instrument such as a synthesizer.

### Description of Reference Numerals

1,100 synthesizer (electronic apparatus)
11a musical tone output program (output program)
11b longest offset time memory (portion of offset time storage part)
50 portable terminal (external apparatus)
Pr1 to Pr35 reception timing
S1, S2 performance information reception part, TS reception part, performance information reception step, TS reception step
S5 reference timing setting part, reference timing setting step
S4, S6 scheduled output timing setting part, scheduled output timing setting step
S32 offset time acquisition part
S33, S34 portion of offset time storage part

1. An electronic apparatus, comprising:
a performance information reception part, receiving pieces of performance information from an external apparatus;
a TS reception part, receiving, from the external apparatus, timestamps relating to respective execution timings of the pieces of performance information received by the performance information reception part;
a reference timing setting part, in a case where one piece of performance information is received by the performance information reception part, setting a timing based on a reception timing of the one piece of performance information as a reference timing; and
a scheduled output timing setting part, setting, as a scheduled output timing being a timing of outputting another piece of performance information received by the performance information reception part, a timing calculated by adding a time difference between a timestamp received by the TS reception part that corresponds to the another piece of performance information and a timestamp received by the TS reception part that corresponds to the one piece of performance information to the reference timing set by the reference timing setting part, wherein,
in a case where the scheduled output timing set by the scheduled output timing setting part is at or before a reception timing of the another piece of performance information, the reference timing setting part sets a timing based on the reception timing of the another piece of performance information as the reference timing.

2. The electronic apparatus according to claim 1, wherein,
in a case where an initial piece of performance information is received by the performance information reception part, the reference timing setting part sets a reception timing of the initial piece of performance information as the reference timing; and
in a case where the initial piece of performance information is received by the performance information reception part, the scheduled output timing setting part sets a reception timing of the initial piece of performance information as the scheduled output timing for the initial piece of performance information.

3. The electronic apparatus according to claim 2, comprising:
an offset time acquisition part, acquiring an offset time being a time difference between the scheduled output timing set by the scheduled output timing setting part and a reception timing of a piece of performance information corresponding to the scheduled output timing; and
an offset time storage part, storing a time based on the offset time acquired by the offset time acquisition part as a delay offset time, wherein,
in a case where the initial piece of performance information is received by the performance information reception part, the reference timing setting part sets a timing calculated by adding the delay offset time stored in the offset time storage part to a reception timing of the initial piece of performance information as the reference timing; and
in a case where the initial piece of performance information is received by the performance information reception part, the scheduled output timing setting part sets a timing calculated by adding the delay offset time stored in the offset time storage part to a reception timing of the initial piece of performance information as the scheduled output timing for the initial piece of performance information.

4. The electronic apparatus according to claim 3, wherein
the offset time storage part stores a time based on the longest offset time among the offset times acquired by the offset time acquisition part as the delay offset time.

5. The electronic apparatus according to claim 3, wherein,
in a case where the initial piece of performance information is received by the performance information reception part, the reference timing setting part sets a timing calculated by adding a time shorter than the delay offset time stored in the offset time storage part to a reception timing of the initial piece of performance information as the reference timing; and
in a case where the initial piece of performance information is received by the performance information reception part, the scheduled output timing setting part sets a timing calculated by adding a time shorter than the delay offset time stored in the offset time storage part to a reception timing of the initial piece of performance information as the scheduled output timing for the initial piece of performance information.

6. (canceled)

7. The electronic apparatus according to claim 1, wherein,
in a case where another piece of performance information is received by the performance information reception part, the reference timing setting part sets a timing ahead of a reception timing of the another piece of performance information as the reference timing.

8. The electronic apparatus according to claim 7, wherein,
in a case where the scheduled output timing set by the scheduled output timing setting part is at or before a reception timing of the another piece of performance information, the reference timing setting part sets a timing ahead of the reception timing by a time based on a time difference between the reception timing and the scheduled output timing as the reference timing.

9. A non-transitory computer-readable medium storing an output program, the output program causing a computer to execute processing for outputting received performance information, wherein the output program causes the computer to execute:
a performance information reception step, in which pieces of performance information are received from an external apparatus;
a TS reception step, in which timestamps relating to respective execution timings of the pieces of performance information received by the performance information reception step are received from the external apparatus;
a reference timing setting step, in which, in a case where one piece of performance information is received by the performance information reception step, a timing based on a reception timing of the one piece of performance information is set as a reference timing; and
a scheduled output timing setting step, in which, as a scheduled output timing being a timing of outputting another piece of performance information received by the performance information reception step, a timing calculated by adding a time difference between a timestamp received by the TS reception step that corresponds to the another piece of performance information and a timestamp received by the TS reception step that corresponds to the one piece of performance information to the reference timing set by the reference timing setting step is set, wherein
in the reference timing setting step, in a case where the scheduled output timing set by the scheduled output timing setting step is at or before a reception timing of the another piece of performance information, a timing based on the reception timing of the another piece of performance information is set as the reference timing.

10. An output method comprising:
receiving pieces of performance information from an external apparatus;
receiving timestamps relating to respective execution timings of the pieces of performance information received by the receiving of the pieces of performance information from the external apparatus;
in a case where one piece of performance information is received by the receiving of the pieces of performance information, setting a timing based on a reception timing of the one piece of performance information as a reference timing; and
setting, as a scheduled output timing being a timing of outputting another piece of performance information received by the receiving of the another piece of performance information, a timing calculated by adding a time difference between a timestamp received by the receiving of a timestamp that corresponds to the another piece of performance information and a timestamp received by the receiving of a timestamp that corresponds to the one piece of performance information to the reference timing set by the setting of the reference timing, wherein
in the receiving of the reference timing, in a case where the scheduled output timing set by the setting of the scheduled output timing is at or before a reception timing of the another piece of performance information, a timing based on the reception timing of the another piece of performance information is set as the reference timing.

11. The electronic apparatus according to claim 4, wherein,
in a case where the initial piece of performance information is received by the performance information reception part, the reference timing setting part sets a timing calculated by adding a time shorter than the delay offset time stored in the offset time storage part to a reception timing of the initial piece of performance information as the reference timing; and
in a case where the initial piece of performance information is received by the performance information reception part, the scheduled output timing setting part sets a timing calculated by adding a time shorter than the delay offset time stored in the offset time storage part to a reception timing of the initial piece of performance information as the scheduled output timing for the initial piece of performance information.

12. The electronic apparatus according to claim 1, wherein
the one piece of performance information is a dummy piece of performance information that does not contain information relating to tone generation, and the another piece of performance information is information that contains information relating to tone generation.
